(19) United States
(12) Patent Application Publication
(10) Pub. No.: US 2013/0304352 A1
(43) Pub. Date: Nov. 14, 2013

(54) ON-BOARD DIAGNOSTIC METHOD AND SYSTEM FOR DETECTING MALFUNCTION CONDITIONS IN MULTIAIR ENGINE HYDRAULIC VALVE TRAIN

(71) Applicants: Glen R. Macfarlane, Howell, MI (US); Peter G. Hartman, West Bloomfield, MI (US)

(72) Inventors: Glen R. Macfarlane, Howell, MI (US); Peter G. Hartman, West Bloomfield, MI (US)

(73) Assignee: CHRYSLER GROUP LLC, Auburn Hills, MI (US)

(21) Appl. No.: 13/469,646

(22) Filed: May 11, 2012

(51) Int. Cl. G01M 15/04

(52) U.S. Cl. 701/102; 701/99

(57) ABSTRACT

An on-board diagnostic system for detecting malfunction conditions in a hydraulic valve train of a MultiAir™ engine. The system comprises a plurality of pressure sensors for generating pressure signals located in a hydraulic circuit of the hydraulic valve train; and an engine control module for performing a waveform analysis of the pressure signals to detect malfunction conditions in the hydraulic valve train. The engine control module performs a frequency and/or time delay waveform analysis.

### FIELD

The present disclosure relates to an on-board diagnostic system for hydraulic valve trains, as used in MultiAir™ engines.

### BACKGROUND

On-board diagnostic systems are common on traditional internal combustion engines of automotive vehicles. The systems are used to monitor the performance of components of the engine. On-board diagnostic systems typically involve a number of sensors and a data processor, which is integrated with the vehicle's electronic control module. The systems alert the driver (using, e.g., a dashboard light) to any malfunctions that occur. By providing this warning, potential problems in the engine can be identified early and before the problems increase in severity.

Modern on-board diagnostic implementations typically provide real-time data while also recording appropriate codes from a standardized series of diagnostic trouble codes. When the vehicle is serviced, this information can be downloaded and displayed to the service personnel to facilitate the troubleshooting process.

Recent developments in internal combustion engine technology have led to newly developed MultiAir™ engine technology. MultiAir™ engines are different from traditional internal combustion engines in that they contain a valve train with electro-hydraulic actuation technology, instead of a traditional camshaft, to provide full control over valve lift and timing. Accordingly, there is a need to provide an on-board diagnostic system for a hydraulic valve train of a MultiAir™ engine.

### SUMMARY

In one form, the present disclosure provides an on-board diagnostic system for detecting malfunction conditions in a hydraulic valve train of a MultiAir™ engine. The system comprises a plurality of pressure sensors for generating pressure signals located in a hydraulic circuit of the hydraulic valve train, and an engine control module for performing a waveform analysis of the pressure signals to detect malfunction conditions in the hydraulic valve train.

Generally, the plurality of pressure sensors are in communication with the engine control module. The engine control module performs a frequency waveform analysis and/or time delay waveform analysis. For example, a first pressure sensor is located between a pump and a solenoid valve of the hydraulic valve train, a second pressure sensor is located between the solenoid valve and a valve actuator of the hydraulic valve train, and a third pressure sensor is located between the solenoid valve and an accumulator of the hydraulic valve train.

The present disclosure also provides a system that comprises a manifold absolute pressure sensor. The manifold absolute pressure sensor is generally located in an intake manifold of the MultiAir™ engine and is in communication with the engine control module.

The present disclosure further provides a system that comprises an oxygen sensor. The oxygen sensor is generally located in an exhaust manifold of the MultiAir™ engine and is in communication with the engine control module.

The system can also comprise notification means to inform an operator if the engine control module detects a malfunction condition in the hydraulic valve train.

The present disclosure also provides a method of detecting malfunction conditions in a hydraulic valve train of a MultiAir™ engine. The method comprises obtaining pressure signals from a plurality of pressure sensors located in a hydraulic circuit of the hydraulic valve train. The method also comprises transmitting the pressure signals from the plurality of pressure sensors to an engine control module. The system further comprises performing a waveform analysis of the pressure signals at the engine control module and identifying malfunction conditions in the hydraulic valve train based on the results of the waveform analysis.

Further areas of applicability of the present disclosure will become apparent from the detailed description and claims provided hereinafter. It should be understood that the detailed description, including disclosed embodiments and drawings, are merely exemplary in nature intended for purposes of illustration only and are not intended to limit the scope of the invention, its application or use. Thus, variations that do not depart from the gist of the invention are intended to be within the scope of the invention.

### BRIEF DESCRIPTION OF THE DRAWINGS

FIG. 1 is a schematic of an on-board diagnostic system for detecting malfunction conditions in a hydraulic valve train of a MultiAir™ engine;

FIG. 2 is a schematic of a hydraulic valve train of a MultiAir™ engine;

FIG. 3 illustrates an exemplary time delay waveform analysis;

FIG. 3A illustrates additional waveforms;

FIG. 4 illustrates an exemplary frequency waveform analysis; and

FIG. 5 is a flowchart of a method of detecting malfunction conditions in a hydraulic valve train of a MultiAir™ engine.

### DETAILED DESCRIPTION

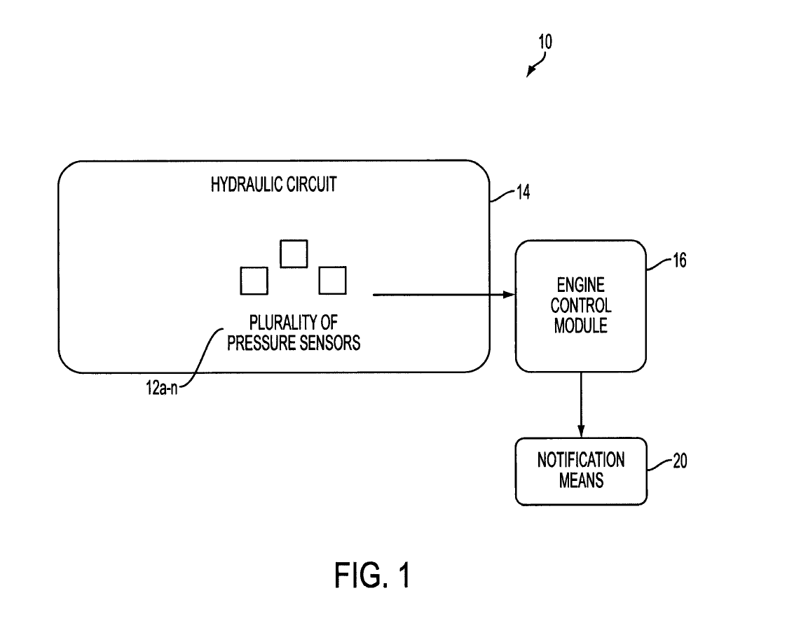

FIG. 1 represents an on-board diagnostic system 10 for detecting malfunction conditions in a hydraulic valve train of a MultiAir™ engine. The system 10 comprises a plurality of pressure sensors 12a-n, which can include as many pressure sensors as needed to monitor all parts and functions of the hydraulic valve train. The plurality of pressure sensors 12a-n are located in a hydraulic circuit 14 of the MultiAir™ engine hydraulic valve train. The plurality of pressure sensors 12a-n generate pressure signals from hydraulic fluid in the hydraulic circuit 14.

The system 10 also comprises an engine control module 16, in communication with, including receiving and processing the pressure signals transmitted from, the plurality of pressure sensors 12a-n. The engine control module 16 is configured to perform a waveform analysis of the pressure signals. The waveform analysis observes current operating conditions and detects malfunction conditions, or failure modes, in the hydraulic valve train. Malfunction conditions are scenarios in which the hydraulic valve train is malfunctioning. For example, one exemplary malfunction condition is a leak in the hydraulic valve train where hydraulic fluid is escaping. A second exemplary malfunction condition is a worn or stuck actuator. A third exemplary malfunction condition is a stuck solenoid. A fourth exemplary malfunction condition is a sticky valve where one valve is moving abnormally slow. A fifth exemplary malfunction condition is a waving valve where one valve opens more than another valve. A sixth exemplary malfunction condition is an improperly functioning accumulator. When malfunction conditions, such as the examples set forth above, are detected, corresponding malfunction condition information can be stored in the engine control module 16. A notification means 20, such as an on-board computer or illuminating lamp, also informs an operator of the malfunctioning hydraulic valve train.

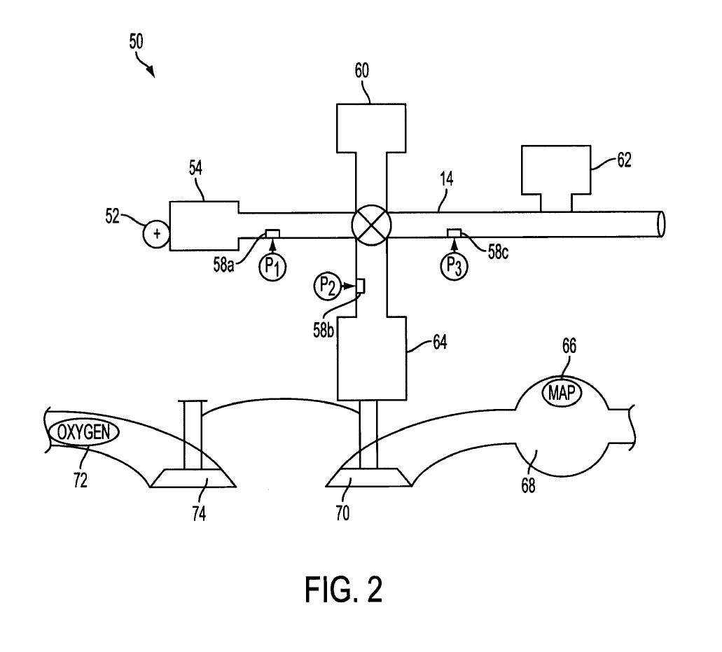

FIG. 2 represents a hydraulic valve train 50 of a MultiAir™ engine. The hydraulic valve train 50 includes electro-hydraulic actuation technology and is a critical component of MultiAir™ engine performance. The hydraulic valve train 50 is responsible for the operation of the MultiAir™ engine's valves. In the hydraulic valve train 50, a cam 52 translates rotary motion of the MultiAir™ engine into reciprocating motion necessary to actuate a pump 54. The pump 54 compresses hydraulic fluid and pushes the hydraulic fluid through the hydraulic circuit 14. In operation, the hydraulic circuit 14 becomes a high pressure hydraulic fluid chamber.

A first pressure sensor 58a, second pressure sensor 58b, and third pressure sensor 58c are each connected to and/or in communication with the hydraulic circuit 14 for the purpose of waveform analysis. The pressure sensors 58a, 58b, 58c generate pressure signals based on the pressure of the surrounding hydraulic fluid. The pressure signals are transmitted to the engine control module 16, which performs waveform analysis of the pressure signals. Malfunction conditions are triggered if the waveform analysis detects a malfunction in the hydraulic valve train 50. For example, a hydraulic leak, stuck solenoid, or stuck actuator will generate a different pressure wave and trigger a malfunction condition for on-board diagnostics based on commanded actuation time and/or other feedback from the solenoid actuation.

The first pressure sensor 58a is typically located in the hydraulic circuit 14 and monitors the hydraulic fluid pressure between the pump 54 and a solenoid valve 60. When the solenoid valve 60 is closed (energized state), hydraulic fluid flows to a valve actuator 64. The second pressure sensor 58b is located in the hydraulic circuit 14 and monitors the hydraulic fluid pressure between the solenoid valve 60 and the valve actuator 64. When the solenoid valve 60 is open (de-energized state), hydraulic fluid flows to an accumulator 62. The third pressure sensor 58c is located in the hydraulic circuit 14 and monitors the hydraulic fluid pressure between the solenoid valve 60 and the accumulator 62. The accumulator 62 is a pressure storage reservoir that holds hydraulic fluid under pressure.

The system 10 may also include a manifold absolute pressure sensor 66 to monitor the air entering an intake manifold 68 from an intake valve 70. The manifold absolute pressure sensor 66 generates output signals that comprise information used to calculate air density. The information gathered at the manifold absolute pressure sensor 66 is also used to help determine the engine's air mass flow rate, which in turn determines the required fuel metering for optimum combustion. The manifold absolute pressure sensor 66 is located in the intake manifold 68, which provides fuel and air mixtures to the MultiAir™ engine's cylinders.

Furthermore, the system 10 may include an oxygen sensor 72, which aids in monitoring oxygen levels and detecting malfunctions. The oxygen sensor 72 generates output signals used to determine the level of oxygen in the exhaust gas during operation of the MultiAir™ engine. The oxygen sensor 72 is located in an exhaust manifold 74 that collects and releases exhaust gases generated from the MultiAir™ engine's cylinders.

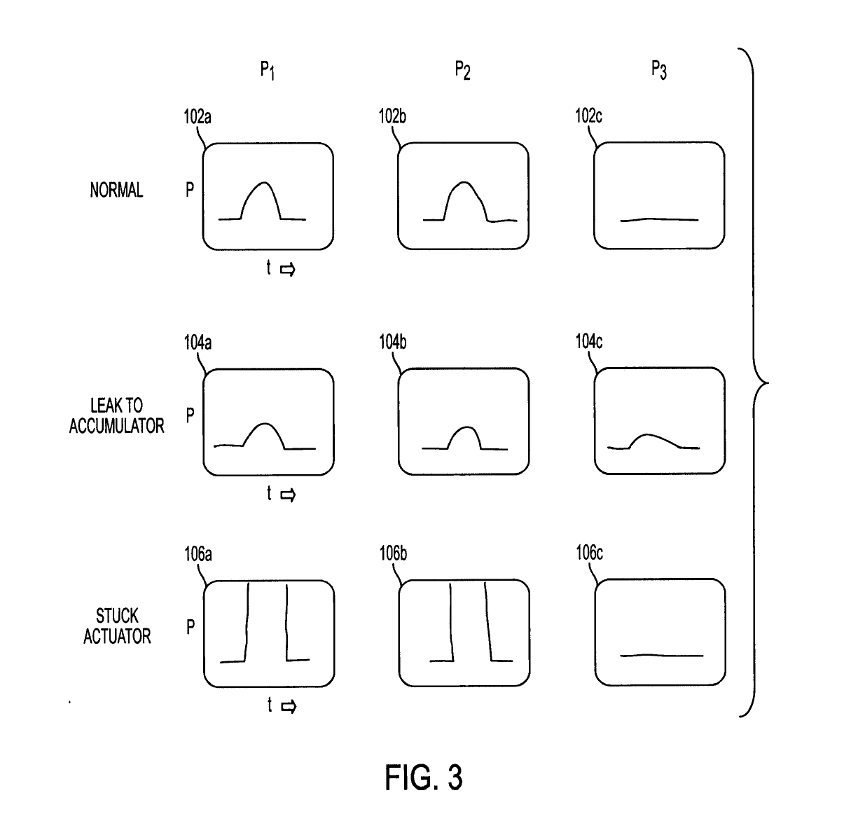

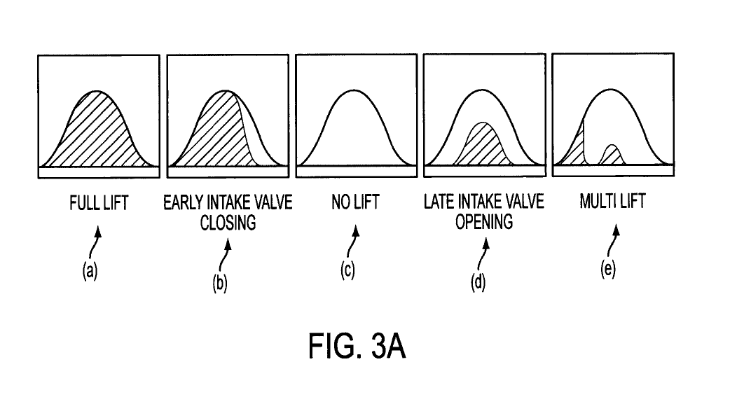

FIG. 3 includes graphs illustrating an exemplary time delay waveform analysis for various operating conditions. The graphs demonstrate the functionality of the hydraulic valve train 50 through a waveform analysis of the time delay of pressure signals. More specifically, the graphs in FIG. 3 demonstrate three exemplary scenarios that can arise during the operation of a MultiAir™ engine. Each scenario is represented by three graphs, one for each of the pressure signals P₁, P₂, and P₃ generated respectively from the first pressure sensor 58a, second pressure sensor 58b, and third pressure sensor 58c. The first pressure sensor 58a generates pressure signals P₁ from the hydraulic fluid pressure between the pump 54 and the solenoid valve 60. The second pressure sensor 58b generates pressure signals P₂ from the hydraulic fluid pressure between the solenoid valve 60 and the valve actuator 64. The third pressure sensor 58c generates pressure signals P₃ from the hydraulic fluid pressure between the solenoid valve 60 and the accumulator 62.

Graphs 102a, 102b, and 102c demonstrate the first scenario, which includes normal operation of the hydraulic valve train 50. Graphs 104a, 104b, and 104c demonstrate the second scenario, which includes a malfunctioning hydraulic valve train 50 resulting from a leak in the accumulator of the hydraulic valve train 50. Graphs 106a, 106b, and 106c demonstrate the third scenario, which includes a malfunctioning valve train 50 resulting from a stuck actuator of the hydraulic valve train 50.

The graph shapes, representing operational conditions, may vary according to the engine configuration, operating conditions, normal, non-normal, and failure mode. For example, the normal operating graph shapes shown in 102a and 102b represent a full valve lift condition. FIG. 3A also illustrates possible graph shapes to represent full lift (a); early intake valve closing (b); no lift (c); late intake valve opening (d); and valve multi-lift condition (e). Those skilled in the art will further appreciate that various valve operational condition combinations are also possible such as portions of (b) and (d); portions of (b) and (e); and portions of (d) and (e). Diagnostic troubleshooting using the graphs may include a comparison of all graphs 102a, 102b, 102c compared to 104a, 104b, and 104c, respectively. The graphs 104a, 104b, 104c may have different shapes, amplitudes and duration compared to the respective normal graph 102a, 102b, 102c, to represent a condition other than normal as compared to graphs 102a, 102b, 102c. In one situation, one of the graphs 104a, 104b, 104c can be a different plot (e.g. same shape, but substantially lower amplitude) compared to its respective normal graph 102a, 102b, 102c, for example due to a flow obstruction in a respective portion of the hydraulic circuit. Several other scenarios can also arise during the operation of a MultiAir™ engine. This disclosure is not limited to the above scenarios.

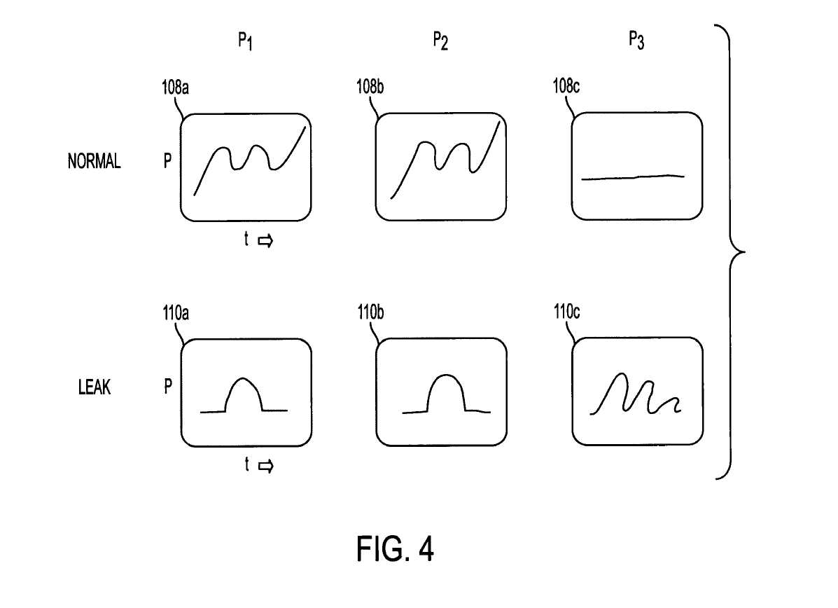

FIG. 4 includes graphs illustrating an exemplary frequency waveform analysis. The graphs demonstrate the functionality of the hydraulic valve train 50 through a waveform analysis of the frequency of pressure signals. More specifically, the graphs demonstrate two exemplary scenarios that can arise during the operation of a MultiAir™ engine. The two scenarios are each represented by three graphs, one for each of the pressure signals P₁, P₂, and P₃ generated respectively from the first pressure sensor 58a, second pressure sensor 58b, and third pressure sensor 58c. As stated previously, the first pressure sensor 58a generates pressure signals P₁ from the hydraulic fluid pressure between the pump 54 and the solenoid valve 60. The second pressure sensor 58b generates pressure signals from the hydraulic fluid pressure between the solenoid valve 60 and the valve actuator 64. The third pressure sensor 58c generates pressure signals P₃ from the hydraulic fluid pressure between the solenoid valve 60 and the accumulator 62.

Graphs 108a, 108b, and 108c demonstrate the first scenario, which includes normal operation of the hydraulic valve train 50. Graphs 110a, 110b, and 110c demonstrate the second scenario, which includes a malfunctioning hydraulic valve train 50 resulting from a leak within the hydraulic valve train 50.

Similar to the discussion above regarding the graph shape possibilities corresponding to the engine configuration and operating conditions, the graphs of frequency waveform analysis 108a, 108b, 108c, 110a, 110b, and 110c can also have different shapes compared to the shapes shown in FIG. 4, corresponding to a particular engine configuration, operating condition, normal, non-normal, and failure mode. Several other scenarios can also arise during the operation of a MultiAir™ engine. This disclosure is not limited to the above scenarios.

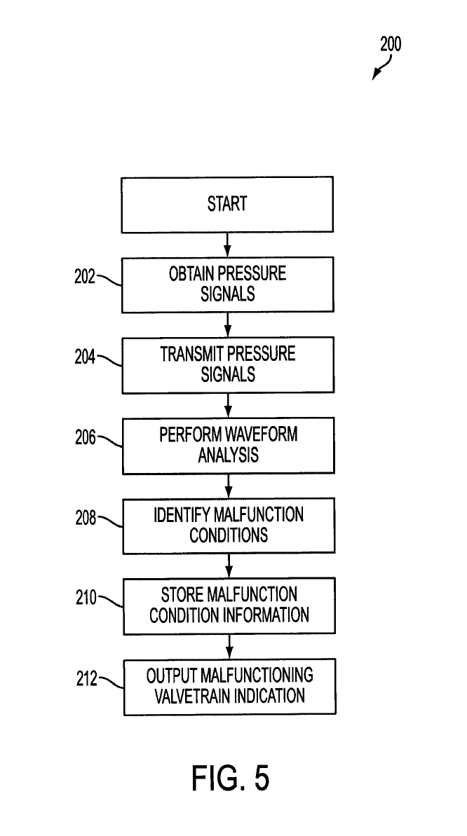

FIG. 5 illustrates a method 200 of detecting malfunction conditions in the hydraulic valve train 50 of a MultiAir™ engine. At step 202, pressure signals are obtained from a plurality of pressure sensors 12a-n. As shown in FIGS. 1 and 2, the plurality of pressure sensors 12a-n are located in hydraulic circuit 14 of the hydraulic valve train 50. More specifically, the pressure signals between the pump 54 and the solenoid valve 60 are generated by a pressure sensor of the plurality of pressure sensors 12a-n. The pressure signals between the solenoid 60 and the valve actuator 64 are generated by a pressure sensor of the plurality of pressure sensors 12a-n. The pressure signals between the solenoid valve 60 and the accumulator 62 are generated by a pressure sensor of the plurality of pressure sensors 12a-n.

At step 204, the pressure signals are transmitted from the plurality of pressure sensors 12a-n to the engine control module 16. The pressure signals are transferred electronically, using, e.g., standard in-vehicle networking technology, such as Local Interconnect Network (LIN), Controller Area Network (CAN), or FlexRay.

At step 206, waveform analysis is performed on the pressure signals. The engine control module 16 performs the waveform analysis and is configured to perform different types of waveform analyses. One type of waveform analysis includes a frequency waveform analysis. In a frequency waveform analysis, pressure is measured against frequency. Another type of waveform analysis includes a time delay waveform analysis. In a time delay waveform analysis, the pressure is measured against time. The engine control module 16 can be configured to perform one type of waveform analysis or simultaneously perform multiple types of waveform analyses.

At step 208, malfunction conditions are identified. A malfunction condition may vary based on the engine configuration, operating condition, non-normal, and failure mode condition. It is to be noted that a certain condition may not be considered a failure mode condition (e.g. a non-operating valve), but could be some other non-normal, yet undesirable, condition such as a partial flow obstruction if undetected could lead to a failure mode. In one example of the method, the engine control module 16 identifies a malfunctioning hydraulic valve train 50 based on the results of the waveform analysis (step 206). At step 210, malfunction condition information is stored in the engine control module 16. At step 212, a notification means 20 outputs a malfunctioning valve train indication. The notification can be, e.g., a diagnostic light on the vehicle's dashboard. The stored information can subsequently be retrieved by a diagnostic computer and/or system at a dealership or service station.

What is claimed is:

1. An on-board diagnostic system for detecting malfunction conditions in a hydraulic valve train of a MultiAir™ engine, the system comprising:
a plurality of pressure sensors for generating pressure signals located in a hydraulic circuit of the hydraulic valve train; and
an engine control module for performing a waveform analysis of the pressure signals to detect malfunction conditions in the hydraulic valve train.

2. The system of claim 1, wherein the plurality of pressure sensors are in communication with the engine control module.

3. The system of claim 1, wherein the engine control module performs a frequency waveform analysis.

4. The system of claim 1, wherein the engine control module performs a time delay waveform analysis.

5. The system of claim 1, wherein a first pressure sensor is located between a pump and a solenoid valve of the hydraulic valve train.

6. The system of claim 5, wherein a second pressure sensor is located between the solenoid valve and a valve actuator of the hydraulic valve train.

7. The system of claim 6, wherein a third pressure sensor is located between the solenoid valve and an accumulator of the hydraulic valve train.

8. The system of claim 1, further comprising a manifold absolute pressure sensor located in an intake manifold of the multi-air engine and in communication with the engine control module.

9. The system of claim 1, further comprising an oxygen sensor located in an exhaust manifold of the MultiAir™ engine and in communication with the engine control module.

10. The system of claim 1, further comprising notification means to inform an operator if the engine control module detects a malfunction condition in the hydraulic valve train.

11. A method of detecting malfunction conditions in a hydraulic valve train of a MultiAir™ engine, the method comprising:
obtaining pressure signals from a plurality of pressure sensors located in a hydraulic circuit of the hydraulic valve train;
transmitting the pressure signals from the plurality of pressure sensors to an engine control module;
performing a waveform analysis of the pressure signals at the engine control module; and
identifying malfunction conditions in the hydraulic valve train based on the results of the waveform analysis.

12. The method of claim 11, wherein the engine control module performs a frequency waveform analysis.

13. The method of claim 11, wherein the engine control module performs a time delay waveform analysis.

14. The method of claim 11, wherein a pressure sensor of the plurality of pressure sensors is generating pressure signals between a pump and a solenoid valve of the hydraulic valve train.

15. The method of claim 11, wherein a pressure sensor of the plurality of pressure sensors is generating pressure signals between a solenoid valve and a valve actuator of the hydraulic valve train.

16. The method of claim 11, wherein a pressure sensor of the plurality of pressure sensors is generating pressure signals between a solenoid valve and an accumulator of the hydraulic valve train.

17. The method of claim 11, further comprising analyzing output signals of a manifold absolute pressure sensor located in an intake manifold of the MultiAir™ engine.

18. The method of claim 11, further comprising analyzing output signals of an oxygen sensor located in an exhaust manifold of the MultiAir™ engine to determine oxygen levels during operation of the MultiAir™ engine.

19. The method of claim 11, further comprising storing malfunction condition information in the engine control module.

20. The method of claim 11, further comprising outputting a malfunctioning valve train indication.
